(19) United States
(12) Patent Application Publication
(10) Pub. No.: US 2006/0047541 A1
(43) Pub. Date: Mar. 2, 2006

(54) Method and system for real-time booking by an electronic document

(75) Inventor: Gino Li, Sindian City (TW)

Correspondence Address: BACON & THOMAS, PLLC, 625 SLATERS LANE, FOURTH FLOOR, ALEXANDRIA, VA, 22314, US

(73) Assignee: Gino LI, Sindian City (TW)

(21) Appl. No.: 11/209,734

(22) Filed: Aug. 24, 2005

(30) Foreign Application Priority Data
Aug. 31, 2004 (TW) 093126181

(51) Int. Cl. G06Q 10/00

(52) U.S. Cl. 705/5

(57) ABSTRACT

A method and system for real-time booking by an electronic document. The system has a proxy server, a booking server and a ticket issue system. A user sends booking request data to the proxy server through a mobile phone, wireless phone, computer equipment or portable electronic device connected with a telephone service station or public switched telephone network. Next, the proxy server performs a booking and confirmation procedure on the booking server. Finally, the ticket issue system prints an airline ticket or receipt to thus complete the payment and receipt acquirement procedure.

### BACKGROUND OF THE INVENTION

1. Field of the Invention

The invention relates to a booking method and system and, more particularly, to a method and system for real-time booking by an electronic document.

2. Description of Related Art

It is an important subject of fast and convenient traffic transport in the globalization trend. For example, air transport can bring people all over the world promptly such that business activities and human life are greatly improved. However, it is a problem between a business provider, such as an airline company or a travel agency, and passengers how the business provider can provide passengers to real-time book seats and buy tickets for taking flights in time to their destinations. Conventionally, the airline company or travel agent requires much manpower to handle the booking affairs for their passengers, and the passengers require going to a check-in counter of the airline company or travel agent in person or calling frequently before the airline tickets and the flights are confirmed. Such a way is not practical, especially when a passenger needs to urgently buy a ticket or change the journey.

To overcome this, with the help of the Internet, the airline company, the travel agent or both can provide a booking website. A user can book tickets on the seat booking website by providing appropriate data such as identity (ID) numbers, names, departure dates, return dates, seat booking number, seat classes, room classes, etc., and selecting a payment way such as by credit card or account transfer. The airline company or the travel agent accordingly proceeds the succeeding procedures, e.g., booking the tickets or rooms to the corresponding airlines or hotels and proceeding the payment. As such, it is convenient and saves time to a user, as compared to the prior art, in which the user requires booking for seats or rooms to corresponding airlines or hotels in person.

However, such a network booking way requires an online computer or device to input certain amount of personal information and needs a period of waiting time to obtain a response from a booking website, which is not convenient and real-time to a user, especially when the user locates in a non-network environment, such as remote districts, mountains, or places without any networking device. In this case, the user cannot satisfy with a real-time booking need for plane tickets or hotel rooms. Therefore, it is desirable to provide an improved method and system to mitigate and/or obviate the aforementioned problems.

### SUMMARY OF THE INVENTION

The object of the present invention is to provide a method and system for real-time booking by an electronic document, which can overcome the prior problems.

In accordance with one aspect of the present invention, there is provided a method for real-time booking by an electronic document, wherein a user uses a mobile device to edit a booking request data for being sent out by an electronic document. The method includes the steps of: (A) receiving an electronic document containing a booking request data; (B) verifying a reality of the user; (C) finding a user setting corresponding to the user; (D) booking seats or rooms according to the booking request data and the user setting, and accordingly producing a booking result; (E) reporting the booking result to the mobile device; (F) receiving an electronic document containing a booking data confirmation and sent by the mobile device for confirming the booking request data; and (G) proceeding a payment according to the booking request data and the user setting, and accordingly obtaining a receipt. The method can be performed by a proxy server, and the electronic document can be an email, a short message or a multimedia message.

In accordance with another aspect of the invention, there is provided a system for real-time booking by an electronic document. The system includes: a mobile device to output electronic documents respectively containing a booking request data or a booking data confirmation and receive electronic documents respectively containing a booking result data and a receipt; a proxy server to receive the electronic document containing the booking request data output by the mobile device, combine a user setting and the electronic document containing the booking request data into a booking parameter data to output, receive and transfer the electronic document containing the booking result data to the mobile device, receive the electronic document containing the booking data confirmation, combine the a user setting and the booking result data into a payment data to output, and receive and transfer a ticket print data; a booking server to receive the booking parameter data output by the proxy server, output the booking result data corresponding to the booking parameter data to the proxy server, receive the payment data output by the proxy server, and output the ticket print data corresponding to the payment data to the proxy server; and a ticket issue system to receive the ticket print data and output the receipt corresponding to the ticket print data. The electronic document can be an email, a short message or a multimedia message. The receipt can be an airline ticket, an electronic ticket or a seat allocation printout. The mobile device can be a cellphone, notebook with a wireless communication module, desktop, or personal digital assistant (PDA).

Other objects, advantages, and novel features of the invention will become more apparent from the following detailed description when taken in conjunction with the accompanying drawings.

### BRIEF DESCRIPTION OF THE DRAWINGS

FIG. 1 is a schematic diagram of a system for real-time booking by an electronic document according to a first embodiment of the invention;

FIG. 2 is a schematic diagram of a system for real-time booking by an electronic document according to a second embodiment of the invention; and

FIG. 3 is a flowchart of a method for real-time booking by an electronic document according to the invention.

### DETAILED DESCRIPTION OF THE PREFERRED EMBODIMENT

Two system embodiments and one method embodiment of the invention are given, which use electronic documents to realize a real-time booking for seats or rooms. One embodiment is given as follows, which books airline seats by email, but not limited to this.

### First Embodiment

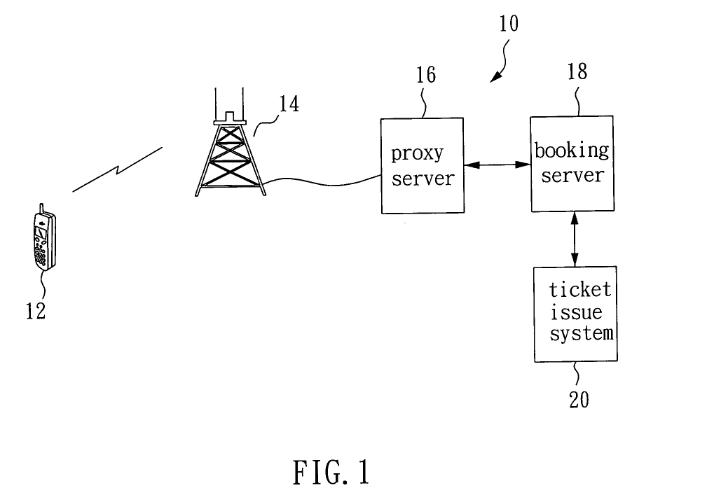

FIG. 1 is a schematic diagram of a system for real-time booking by an electronic document according to a first embodiment of the invention. As shown in FIG. 1, the system 10 includes a mobile device 12, a telephone service station 14, a proxy server 16, a booking server 18 and a ticket issue system 20.

The mobile device 12 is preferably a mobile phone capable of editing, sending and receiving a short message (corresponding to the Short Message Service (SMS), containing a booking request data or a booking data confirmation). The short message is sent to the telephone service station 14 for further transfer. The mobile device 12 can receive a short message containing a booking result data or an electronic ticket through the station 14 as well. The booking request data contains user accounts, predetermined time and locations of departure, predetermined time and locations of return, required ticket number, and even the phone number. The phone number is sent with the short message to the station 14 such that the proxy 16 can verify the reality of a user who books an airline ticket by checking the phone number corresponding to the mobile phone. Instead, the mobile device 12 can be a notebook, desktop or PDA that uses the wireless communication function provided by a wireless communication module to send a short message, multimedia message (corresponding to the Multimedia Messaging Service) or email to the telephone service station 14 for the booking procedure.

The telephone service station 14 is a mobile communication network equipment provided by telecommunication providers, which can sufficiently support wireless communication services. The station 14 can receive the short message with the booking request data or the booking data conformation sent by the mobile device 12 and send it to the proxy server 16, or reversely receive the short message with the booking result data or electronic ticket sent by the proxy server 16 and send it to the mobile device 12.

The proxy server 16 receives the short message with the booking request data sent by the station 14, determines the reality of the user according to the phone number contained in the short message received, reads an internal user setting according to the user accounts, combines the booking request data and the user setting into a booking parameter data, outputs the booking parameter data to the booking server 18, and receives the booking result data sent by the booking server 18 later. When the booking result data indicates the short message with the booking data confirmation, the proxy server 16 combines the booking result data and the user setting into a payment data and outputs the payment data to the booking server 18, thereby completing the payment and receipt acquirement procedure. The booking result data and the electronic ticket are output to the station 14 by a short message for further transfer to the user provided with the mobile device 12. The user setting contains preference data such as the preferences of ticket costs, boarding time, seat locations, airlines and the like, and even the personal information such as credit card number, fax number, electronic document addresses.

The booking server 18 is preferably a global distribution system (GDS) to handle the airline ticket booking affairs, and/or a hotel booking system to handle the room booking affairs. The booking server 18 handles the booking affairs according to the booking parameter data and outputs the booking result data to the proxy server 16. When the booking result data indicates a success, the booking result data contains: a booking success message; airlines, predetermined time, locations and ticket classes of departure; airlines, predetermined time, locations and ticket classes of return; and a ticket number. Conversely, when the booking result data indicates a failure, the booking result data contains a sold-out message. The booking server 18 outputs the short message with the booking result data to the mobile device 12 through the proxy server 16 and the station 14 in order to notice the user the booking result data, and obtains the payment data from the proxy server 16 to accordingly complete the booking and payment procedure if the booking success message is contained and output corresponding ticket print data to the ticket issue system 20.

The ticket issue system 20 outputs a receipt containing electronic ticket according to the ticket print data and sends the receipt to the mobile device 12 through the station 14. The receipt can be an airline ticket or seat allocation printout. The airline ticket or seat allocation printout can be mailed or faxed to the user according to the user setting. Thus, the user can use the airline ticket or seat allocation printout to complete the seat allocation procedure on a check-in counter of the airline company in the airport.

Alternatively, the short message can be replaced with a multimedia message or email, and the booking process is similar to the aforementioned operation and thus a detailed description is deemed unnecessary.

### Second Embodiment

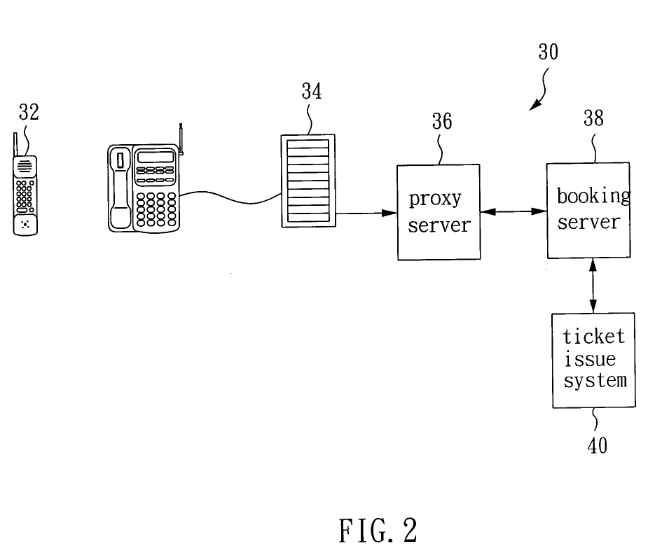

FIG. 2 is a schematic diagram of a system for a real-time booking by an electronic document according to a second embodiment of the invention. As shown in FIG. 2, the system 30 includes a mobile device 32, a public switched telephone network (PSTN) 34, a proxy server 36, a booking server 38 and a ticket issue system 40. The mobile device 32 can be a wireless phone. With this system, a user can input the booking request data on the mobile device 32 by following the indication provided by the PSTN 34, and the PSTN 34 packages the booking request data into the short message and outputs the short message with the booking request data to the proxy server 36. The operations of the devices 36, 38 and 40 in the second embodiment are identical to those of the first embodiment and thus a detailed description is deemed unnecessary.

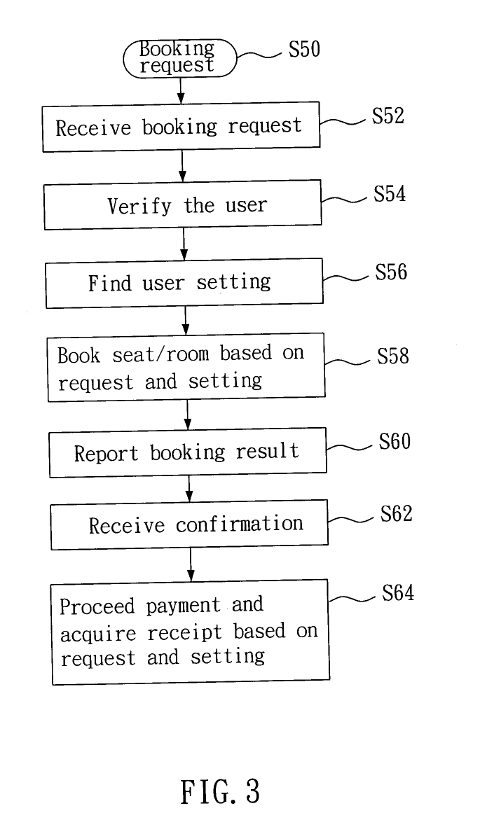

FIG. 3 is a flowchart of a method for real-time booking by an electronic document according to the invention, which includes the following steps:

Step S50 is a booking request step. In this step, the user uses the mobile device 12 to edit the booking request data and send the short message containing the booking request data to the telephone service station 14.

Step S52 is a data receiving step. In this step, the proxy server 16 receives the short message with the booking request data sent by the station 14.

Step S54 is an identity verifying step. In this step, the proxy server 16 verifies the reality of the user by checking the phone number contained in the short message received in the step S52, thereby avoiding any interference from a mal-intended user.

Step S56 is a user setting find step. In this step, the proxy server 16 reads an internal user setting according to the account data provided by the user verified.

Step S58 is a pre-booking step. In this step, the proxy server 16 combines the booking request data and the user setting into a booking parameter data and outputs the booking parameter data to the booking server 18 for proceeding the booking affairs.

Step S60 is a result report step. In this step, when the booking parameter data is received, the booking server 18 handles the booking procedure and accordingly outputs the booking result data to the proxy server 16.

Step S62 is a data confirmation receiving step. In this step, the proxy server 16 sends the short message containing the booking result data to the user. When the short message with the booking result data is received by the mobile device 12, the user can use the mobile device 12 to send the short message containing the booking data confirmation to the proxy server 16 immediately or later, thereby completing the booking confirmation.

Step S64 is a payment and receipt acquirement step. In this step, the proxy server 16 combines the booking result data and the user setting into a payment data and outputs the payment data to the booking server 18 to thus complete the payment. Accordingly, the user can obtain the desired airline ticket or electronic ticket through the ticket issue system 20.

Although the present invention has been explained in relation to its preferred embodiment, it is to be understood that many other possible modifications and variations can be made without departing from the spirit and scope of the invention as hereinafter claimed.

What is claimed is:

1. A system for real-time booking by an electronic document, comprising:
a mobile device, which outputs electronic documents respectively containing a booking request data and a booking data confirmation and receives electronic documents respectively containing a booking result data and a receipt;
a proxy server, which receives the electronic document containing the booking request data output by the mobile device, combines a user setting and the electronic document containing the booking request data into a booking parameter data to output, receives and transfers the electronic document containing the booking result data to the mobile device, receives the electronic document containing the booking data confirmation, and combines the user setting and the booking result data into a payment data to output;
a booking server, which receives the booking parameter data output by the proxy server, outputs the booking result data corresponding to the booking parameter data to the proxy server, receives the payment data output by the proxy server, and outputs a ticket print data corresponding to the payment data to the proxy server; and
a ticket issue system, which receives the ticket print data output by the proxy server and outputs the receipt corresponding to the ticket print data.

2. The system as claimed in claim 1, further comprising a telephone service station to transfer the electronic documents between the mobile device and the proxy server in a wireless manner.

3. The system as claimed in claim 2, wherein the mobile device is a mobile phone.

4. The system as claimed in claim 2, wherein the mobile device is a notebook.

5. The system as claimed in claim 1, wherein the booking server is a global distribution system.

6. The system as claimed in claim 1, wherein the receipt is a plane ticket.

7. A system for making a real-time reservation in an electronic document manner, comprising:
a mobile device, which outputs a booking request data and a booking data confirmation and receives a booking result data;
a public switched telephone network, which receives the booking request data output by the mobile device, packages the booking request data into an electronic document to output, receives an electronic document containing the booking result data, outputs the booking result data to the mobile device, receives the booking data confirmation, packages the booking data confirmation into an electronic document to output;
a proxy server, which receives the electronic document containing the booking request data, combines a user setting and the electronic document containing the booking request data into a booking parameter data to output, receives the booking result data, packages the booking result data into an electronic document to output, receives the electronic document containing the booking data confirmation, combines the booking result data and the user setting a payment data to output;
a booking server, which receives the booking parameter data, outputs the booking result data corresponding to the booking parameter data to the proxy server, receives the payment data output by the proxy server, and outputs a ticket print data corresponding to the payment data to the proxy server; and
a ticket issue system, which receives the ticket print data output by the proxy server and outputs the receipt corresponding to the ticket print data.

8. The system as claimed in claim 7, wherein the mobile device is a wireless phone.

9. The system as claimed in claim 7, wherein the booking server is a global distribution system.

10. The system as claimed in claim 7, wherein the receipt is an electronic ticket.

11. The system as claimed in claim 7, wherein the receipt is an airline ticket.

12. A method for real-time booking by an electronic document, wherein a user uses a mobile device to edit a booking request data for being sent out by an electronic document, the method comprising the steps of:
(A) receiving an electronic document containing the booking request data;
(B) verifying a reality of the user;
(C) finding a user setting corresponding to the user verified;
(D) booking airline seats or hotel rooms according to the booking request data and the user setting, and accordingly producing a booking result;
(E) reporting the booking result to the mobile device;
(F) receiving an electronic document containing a booking data confirmation and sent by the mobile device for confirming the booking request data; and
(G) proceeding a payment according to the booking request data and the user setting and accordingly obtaining a receipt.

13. The method as claimed in claim 12, wherein the receipt is an airline ticket.

14. The method as claimed in claim 12, wherein the reality of the user in step (B) is verified by checking a phone number corresponding to the mobile device and packaged in the electronic document containing the booking request data.
